(19) United States
(12) Patent Application Publication
(10) Pub. No.: US 2008/0311915 A1
(43) Pub. Date: Dec. 18, 2008

(54) SYSTEM AND METHOD FOR PERFORMING HANDOVER IN A WIRELESS COMMUNICATION SYSTEM

(75) Inventors: Geun-Hwi LIM, Seongnam-si (KR); Won-Il ROH, Yongin-si (KR); Yong CHANG, Seongnam-si (KR)

Correspondence Address: Jefferson IP Law, LLP, 1730 M Street, NW, Suite 807, Washington, DC, 20036, US

(73) Assignee: Samsung Electronics Co. Ltd., Suwon-si (KR)

(21) Appl. No.: 12/139,204

(22) Filed: Jun. 13, 2008

(30) Foreign Application Priority Data
Jun. 13, 2007 (KR) 2007-57758

(51) Int. Cl. H04Q 7/20

(52) U.S. Cl. 455/436

(57) ABSTRACT

A system and method for performing a handover in a wireless communication system are provided. In the system and method an MS receives a mobile neighbor advertisement message including PDR information about a serving BS and neighbor BSs from the serving BS, selects candidate BSs based on a location of the MS and the PDR information, determines communication states of the candidate BSs, determines a target BS for the handover according to the determined communication states, and performs the handover to the target BS.

### PRIORITY

This application claims the benefit under 35 U.S.C. § 119(a) of a Korean patent application filed in the Korean Intellectual Property Office on Jun. 13, 2007 and assigned Serial No. 2007-57758, the entire disclosure of which is hereby incorporated by reference.

### BACKGROUND OF THE INVENTION

1. Field of the Invention

The present invention relates to a wireless communication system. More particularly, the present invention relates to a system and method for performing a handover of a Mobile Station (MS) in a wireless communication system.

2. Description of the Related Art

In general, an MS can perform a handover from a serving Base Station (BS) to a target BS in a wireless communication system. The MS periodically receives a Mobile Neighbor Advertisement (MOB_NBR-ADV) message from the serving BS. The MOB_NBR-ADV message includes information about the frequency bands of the serving BS and neighbor BSs, BS Identifiers (IDs), preamble indexes, and information on the capabilities of the BSs.

The MS selects the target BS based on the information about the serving BS and the neighbor BSs included in the MOB_NBR-ADV message.

FIG. 1 illustrates a cell structure where a plurality of micro BSs 100 co-exist with a macro BS 110 in a conventional wireless communication system.

Referring to FIG. 1, the micro BSs 100 are located within the service area of the macro BS 110. Therefore, the macro BS 110 should include information about neighbor macro BSs as well as information about the micro BSs 100 in the MOB_NBR-ADV message.

Consequently, since the MOB_NBR-ADV message includes information about additional BSs, it takes a longer time for the MS to select the target BS.

### SUMMARY OF THE INVENTION

An aspect of the present invention is to address at least the above-mentioned problems and/or disadvantages and to provide at least the advantages described below. Accordingly, an aspect the present invention is to provide a system and method for performing a fast handover of an MS in a wireless communication system.

In accordance with an aspect of the present invention, a method for performing a handover in an MS in a wireless communication system is provided. The method includes receiving a mobile neighbor advertisement message including PDR information about a serving BS and one or more neighbor BSs from the serving BS, selecting one or more candidate BSs based on a location of the MS and the PDR information, determining communication states of the one or more candidate BSs, selecting a target BS for the handover according to the determined communication states, and performing the handover to the target BS.

In accordance with another aspect of the present invention, a system for performing a handover in a wireless communication system is provided. The system includes a MS, a serving BS, and a target BS, wherein the MS receives a mobile neighbor advertisement message including PDR information about the serving BS and one or more neighbor BSs from the serving BS, selects one or more candidate BSs based on a location of the MS and the PDR information, determines communication states of the candidate BSs, selects the target BS for a handover according to the determined communication states, and performs the handover to the target BS.

In accordance with a further aspect of the present invention, a method for performing a handover in an MS in a wireless communication system is provided. The method includes receiving a mobile neighbor advertisement message including Position, Direction and Range (PDR) information about a serving Base Station (BS) and one or more neighbor BSs from the serving BS, receiving a reference signal from at least one BS and measuring a strength of the reference signal, defining at least two reception signal strength areas for each BS according to the measured reference signal strength and the PDR information, determining a reception signal strength area corresponding to a location of the MS, determining priority levels of BSs based on the determined reception signal strength area, determining channel states between the MS and each of the BSs in a descending order of priority levels of the BSs, and performing a handover to a BS in a best channel state.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 illustrates a case where a plurality of micro BSs co-exist with a macro BS in a conventional wireless communication system;

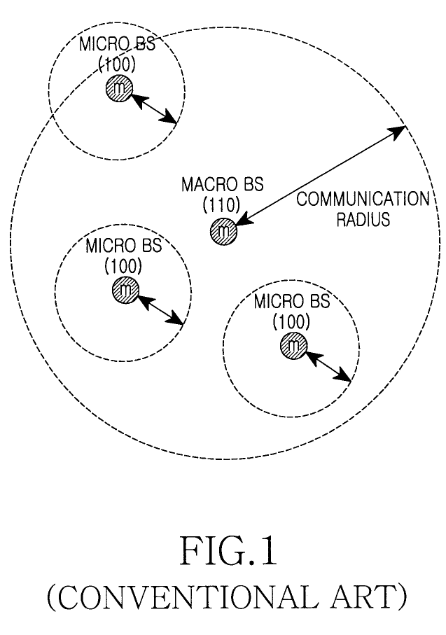

FIG. 2 is a flowchart illustrating a handover operation of an MS in a wireless communication system, according to an exemplary embodiment of the present invention;

FIG. 3 illustrates a case where an MS selects candidate BSs, taking into account Position, Direction and Range (PDR) information in a wireless communication system, according to an exemplary embodiment of the present invention; and

FIG. 4 illustrates an area in which candidate BSs are selected based on PDR information, according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein may be made without departing from the scope and spirit of the invention. Also, descriptions of well-known functions and constructions are omitted for clarity and conciseness.

Exemplary embodiments of the present invention provide a system and method for performing a fast handover of an MS in a wireless communication system. For this purpose, exemplary embodiments of the present invention add new PDR information to a conventional MOB_NBR-ADV message. The PDR information includes at least one of information about the positions of BSs, information about their antenna directions, and information about their communication ranges. The PDR information may be configured as illustrated in Table 1.

TABLE 1

| Name | Type | Length | Value |
|---|---|---|---|
| Position | 120 | 6 | BS position (latitude and longitude) |
| | | | 3 bytes: Latitude |
| | | | 3 bytes: Longitude |
| Direction | 121 | 4 | BS antenna direction (start direction and |
| | | | end direction) |
| | | | 2 bytes: start degree |
| | | | 2 byte: end degree |
| Range | 122 | 2 | BS communication range (Ex: meter) |
| | | | 2 bytes: coverage (meter) |

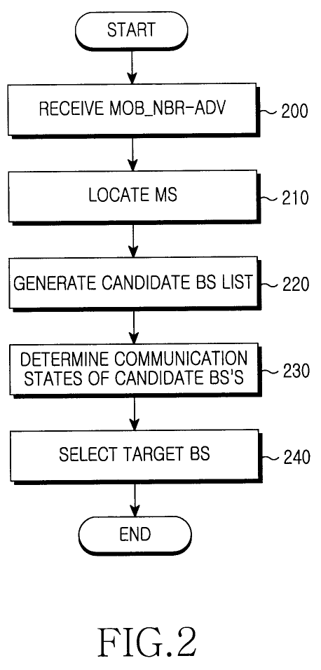

FIG. 2 is a flowchart illustrating a handover operation of an MS in a wireless communication system according to an exemplary embodiment of the present invention.

Referring to FIG. 2, the MS receives a MOB_NBR-ADV message including PDR information from a serving BS in step 200 and determines its location in step 210. The MS may determine its location using any one of a Global Positioning Service (GPS), triangulation, or the like. In step 220, the MS selects candidate BSs based on its location and the PDR information and generates a list of the selected candidate BSs.

The MS determines the communication states of the listed candidate BSs in step 230. The communication states may be determined according to signal strengths between the candidate BSs and the MS, for example, Carrier-to-Interference and Noise Ratios (CINRs).

In step 240, the MS selects a candidate BS with the highest reception signal strength as a target BS and performs a handover to the target BS.

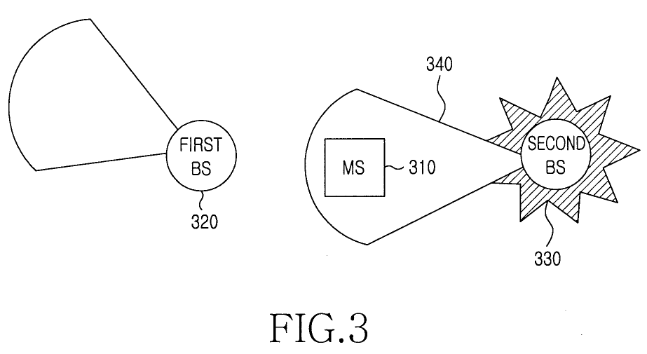

FIG. 3 illustrates a case where an MS selects candidate BSs, taking into account PDR information in a wireless communication system according to an exemplary embodiment of the present invention.

Referring to FIG. 3, an MS 310 selects a candidate BS, taking into account at least one of the locations of first and second BSs 320 and 330, the antenna directions of the first and second BSs 320 and 330, and the distances between the MS 310 and the first and second BSs 320 and 330, which are included in PDR information. The candidate BS may be the second BS 330. That is, the MS 310 selects, as a candidate BS, the second BS 330 corresponding to a fan shape 340 that is defined by at least one of the positions, antenna directions, and distances of the first and second BSs 320 and 330.

If other BSs further satisfy the fan shape 340, the MS 310 measures the signal strengths from the BSs including the second BS 330 and selects a BS with the highest signal strength as a target BS.

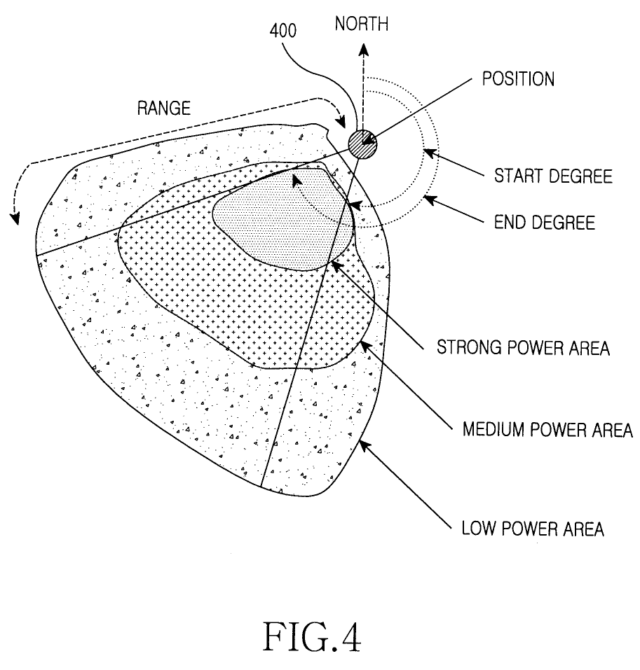

FIG. 4 illustrates an area in which candidate BSs are selected based on PDR information according to an exemplary embodiment of the present invention.

Referring to FIG. 4, an MS classifies a reception signal strength area of each BS based on PDR information received from at least one BS. Three reception signal strength areas may be defined according to the strengths of received signals, namely a strong power area, a medium power area, and a low power area. The received signals may be reference signals, for example. However, the number of reception signal strength areas may be two or less, or four or larger depending on an implementation of the system. In addition, the reception signal strength area of a BS may be determined to be any one of the strong power area, the medium power area, and the low power area by comparing the strength of a signal received from the BS with preset thresholds.

The strong power area may be an area positioned between the start degree and the end degree of an antenna of a BS 400, covering approximately a third of the communication range of the BS 400. The medium power area may be defined to be an area covering approximately two thirds of the communication range of the BS 400, and does not include the strong power area. The low power area may be an area covering approximately the entire communication range of the BS 400, and does not include the strong power area and the medium power area. Both the medium power area and the low power area may also be positioned between the start degree and the end degree of the BS 400. In the illustrated case of FIG. 4, each area covers beyond the area between the start and end degrees due to signal propagation characteristics.

If an MS is located in the strong power area, it determines the BS to be a highest-priority candidate BS. In the medium power area, the MS determines the BS to be the second highest-priority candidate BS. In the low power area, the MS determines the BS to be the third highest-priority candidate BS.

The MS determines the channel states of BSs in a descending order of priority and performs a handover to a BS that would yield the best channel state.

As is apparent from the above description of the exemplary embodiments of the present invention, an MS selects a target BS based on its location and PDR information in a wireless communication system. Therefore, the time required for searching for neighbor BSs is reduced and thus a fast handover is enabled.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for performing a handover in a Mobile Station (MS) in a wireless communication system, comprising:
receiving a mobile neighbor advertisement message including Position, Direction and Range (PDR) information about a serving Base Station (BS) and one or more neighbor BSs from the serving BS;
selecting one or more candidate BSs based on a location of the MS and the PDR information;
determining communication states of the one or more candidate BSs;
selecting a target BS for the handover according to the determined communication states; and
performing the handover to the target BS.

2. The method of claim 1, wherein the PDR information includes information about at least one of a position, antenna direction, and communication range of each of the serving BS and the one or more neighbor BSs.

3. The method of claim 1, wherein the determining of the communication state comprises measuring strengths of signals received from the one or more candidate BSs.

4. The method of claim 1, wherein the selecting of the target BS comprises:
measuring strengths of reference signals received from the one or more candidate BSs; and
selecting a BS with a highest reference signal strength as the target BS.

5. The method of claim 1, further comprising generating a list of the selected one or more candidate BSs.

6. The method of claim 1, further comprising determining a location of the MS.

7. A system for performing a handover in a wireless communication system, comprising:
a Mobile Station (MS);
a serving Base Station (BS); and
a target BS,
wherein the MS receives a mobile neighbor advertisement message including Position, Direction and Range (PDR) information about the serving BS and one or more neighbor BSs from the serving BS, selects one or more candidate BSs based on a location of the MS and the PDR information, determines communication states of the candidate BSs, selects the target BS for a handover according to the determined communication states, and performs the handover to the target BS.

8. The system of claim 7, wherein the PDR information includes information about at least one of a position, antenna direction, and communication range of each of the serving BS and the one or more neighbor BSs.

9. The system of claim 7, wherein the MS measures strengths of signals received from the one or more candidate BSs.

10. The system of claim 7, wherein the MS measures strengths of reference signals received from the one or more candidate BSs, and selects a BS with a highest reference signal strength as the target BS.

11. The system of claim 7, wherein the MS generates a list of the selected one or more candidate BSs.

12. The system of claim 7, wherein the MS determines its location.

13. A method for performing a handover in a Mobile Station (MS) in a wireless communication system, comprising:
receiving a mobile neighbor advertisement message including Position, Direction and Range (PDR) information about a serving Base Station (BS) and one or more neighbor BSs from the serving BS;
receiving a reference signal from at least one BS and measuring a strength of the reference signal;
defining at least two reception signal strength areas for each BS according to the measured reference signal strength and the PDR information;
determining a reception signal strength area corresponding to a location of the MS;
determining priority levels of BSs based on the determined reception signal strength area;
determining channel states between the MS and each of the BSs in a descending order of priority levels of the BSs; and
performing a handover to a BS in a best channel state.

14. The method of claim 13, wherein the PDR information includes information about at least one of a position, antenna direction, and communication range of each of the BSs.

15. The method of claim 13, further comprising determining a location of the MS.
